(19) United States
(12) Patent Application Publication
(10) Pub. No.: US 2014/0143328 A1
(43) Pub. Date: May 22, 2014

(54) SYSTEMS AND METHODS FOR CONTEXT TRIGGERED UPDATES BETWEEN MOBILE DEVICES

(71) Applicant: MOTOROLA SOLUTIONS, INC., Schaumburg, IL (US)

(72) Inventors: TRENT J. MILLER, WEST CHICAGO, IL (US); TYRONE D. BEKIARES, PARK RIDGE, IL (US); TIMOTHY J. COLLINS, HOMER GLEN, IL (US); DEBORAH J. MONKS, PALATINE, IL (US)

(21) Appl. No.: 13/682,126

(22) Filed: Nov. 20, 2012

(51) Int. Cl. H04L 29/06

(52) U.S. Cl. CPC H04L 65/403
USPC 709/204

(57) ABSTRACT

A context-based method, a server implementing a group management function, and a mobile device predicate content delivery between mobile devices based on context. The context can include sensed events at one mobile device such as, without limitation, motion, prone positions, stress, injury, and the like. The context triggered update systems and methods can operate between two mobile devices where a determination of the context on a first mobile device formulates an update to a second mobile device with the update presented to the second mobile device based on the context. That is, the context from the first mobile device is used to formulate an update and an optimal delivery method to the second mobile device.

### FIELD OF THE DISCLOSURE

The present disclosure relates generally to wireless networking via mobile devices and more particularly to systems and methods for context triggered updates between mobile devices that predicate updates between mobile devices based on sensed events.

### BACKGROUND

Wireless networking has become ubiquitous with the widespread deployment of mobile devices including so-called smart devices with vast capabilities. Advantageously, conventional mobile devices enable delivery of significant amounts of data to end users enabling a plurality of applications and uses. For example, mobile devices are useful in the context of public safety. Specifically, responders such as police officers, fire fighters, emergency medical personnel, private security, military, government officials, and the like can utilize mobile devices in the field. Responders often work in groups of two or more (e.g., primary responders, backup responders, etc.). For example, a foot-based police officer in a city would likely have a back-up responder on foot nearby, i.e. a partner responsible for back up. Additionally, mobile devices are expanding beyond hand-held devices to include augmented reality glasses technology, other body-worn display technology, and the like. Further, mobile devices are including various sensor devices therein which are able to detect various events or conditions.

In the context of public safety and the like, it would be advantageous to predicate updates between mobile devices based on context. For example, if a responder's partner is in trouble and/or in a stressful situation, it is imperative that the responder is notified as quickly as possible to have the most impact with the constraint of ensuring the responder is able to receive the update or how the responder receives the update based on the responder's context.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of a context delivery system in accordance with some embodiments.

FIG. 2 is a block diagram of mobile devices for use in the context delivery system and the various methods described herein in accordance with some embodiments.

FIG. 3 is a block diagram illustrates an exemplary implementation of a server for use in the context delivery system and the various methods described herein in accordance with some embodiments.

FIG. 4 is a flowchart of a context-based method in accordance with some embodiments

FIG. 5 is a flowchart of a sensor method for use with the context-based method of FIG. 4 in accordance with some embodiments.

FIG. 6 is a flowchart of a presentation method for use with the context-based method of FIG. 4 in accordance with some embodiments.

FIG. 7 is a flowchart of a group management function (GMF) method for use with the context-based method of FIG. 4 in accordance with some embodiments.

FIG. 8 is a flowchart of a distance correction method for use with the context-based method of FIG. 4 in accordance with some embodiments.

FIG. 9 is a flowchart of a GMF method for use with the context delivery system of FIG. 1 in accordance with some embodiments.

FIG. 10, in an exemplary embodiment, a diagram illustrates an exemplary operation using the context-based systems and methods described herein in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In various exemplary embodiments, context triggered update systems and methods predicate content delivery between mobile devices based on context. The context triggered update systems and methods can be utilized with responders in public safety applications. As described herein, context can include sensed events at one mobile device such as, without limitation, motion (i.e., responder running), prone positions (i.e., responder fallen), stress (i.e., responder has elevated heart rate, responder is injured, responder has low/high pulse, etc.), and the like. The context triggered update systems and methods can operate between two mobile devices where a determination of the context on a first mobile device formulates an update to a second mobile device, or vice versa, with the update presented to the second mobile device based on a context of the first mobile device. That is, the context from the first mobile device is used to formulate an update and an optimal delivery method to the second mobile device.

In an exemplary embodiment, a method includes receiving, at a group management function (GMF), contextual event information and a location from a first mobile device; determining, by the GMF, a set of one or more mobile devices for receiving an update related to the contextual event information and the location of the first mobile device; determining, based on the contextual event information and the location of the first mobile device, for each mobile device in the set of one or more mobile devices optimal content and an optimal delivery mechanism of the contextual event information; processing the contextual event information for at least one mobile device; and sending, by the GMF, the contextual event information and the location of the first mobile device to the at least one mobile device using the optimal delivery mechanism.

In another exemplary embodiment, a server implementing a group management function includes a network interface communicatively coupled to a plurality of mobile devices over a network; a processor communicatively coupled to the network interface; and memory storing instructions that, when executed, cause the processor to: receive, at the group management function (GMF), contextual event information and a location from of a first mobile device; determine, by the GMF, a set of one or more mobile devices for receiving an update related to the contextual event information and the location of the first mobile device; process the contextual event information for at least one mobile device in the set of one or more mobile devices; and send, by the GMF, the processed contextual event information and the location of the first mobile device to the at least one mobile device using the optimal delivery mechanism.

In yet another exemplary embodiment, a mobile device includes a network interface communicatively coupled to a network; at least one sensor capturing data; a processor communicatively coupled to the network interface and the at least one sensor; and memory storing instructions that, when executed, cause the processor to: register for at least one group in a group management function (GMF) at a server; monitor the data from the at least one sensor; determine a context from the monitored data; send the context to the GMF at the server; receive an update related to a direction and a distance to a second mobile device which is part of the at least one group, wherein the update is based upon the second mobile device detecting a contextual event via at least one sensor associated with the second mobile device; and present the update based on the determined context.

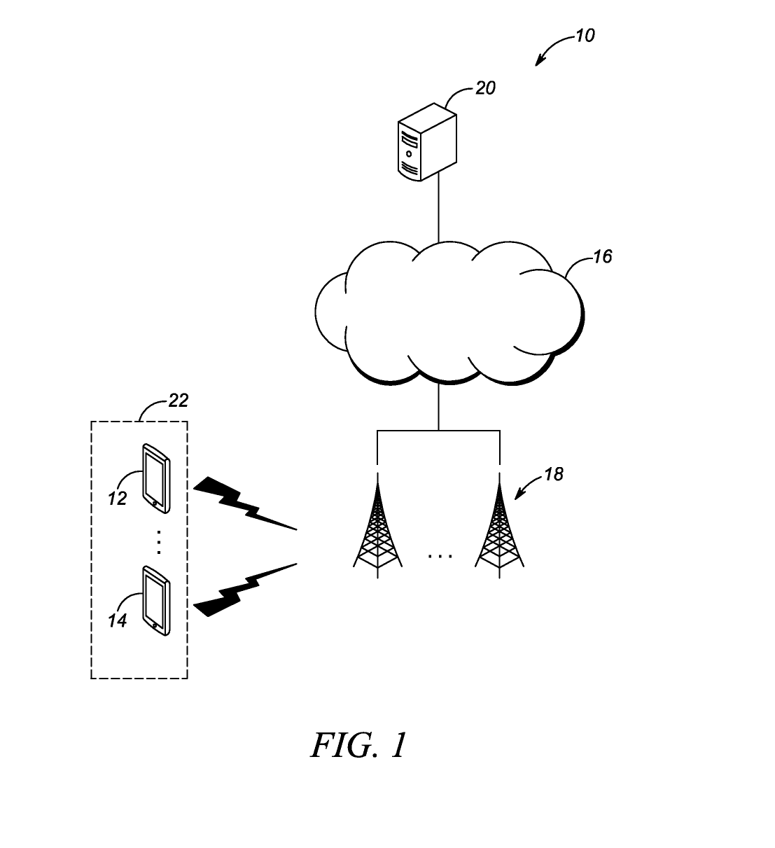

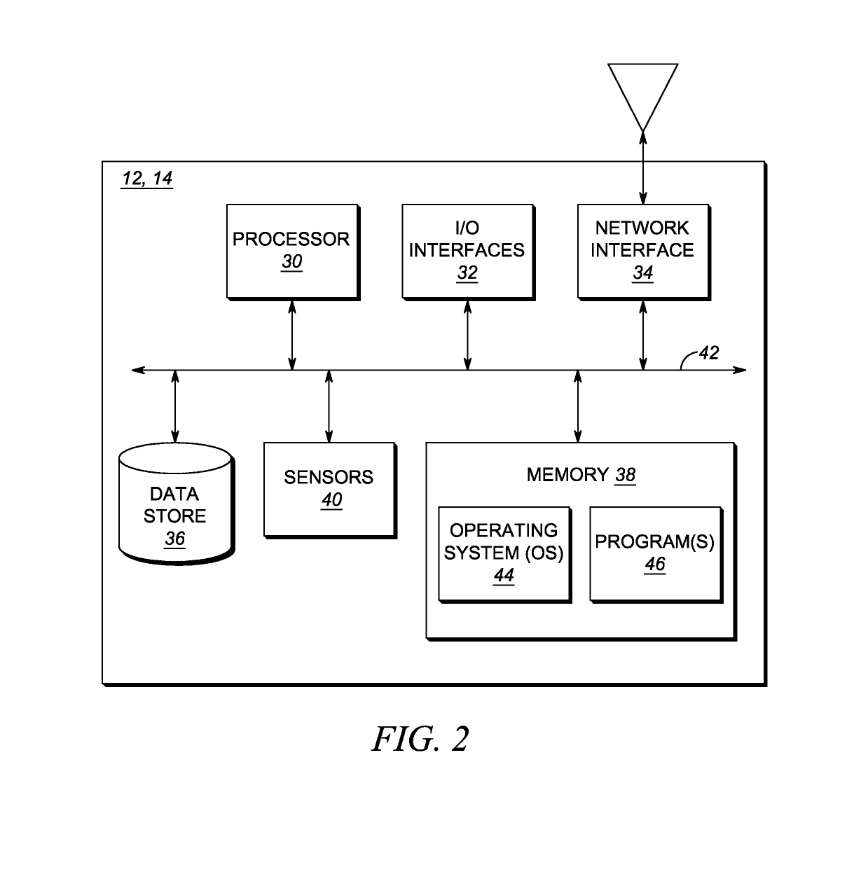

Referring to FIG. 1, in an exemplary embodiment, a network diagram illustrates a context delivery system 10 in accordance with some embodiments. The context delivery system 10 includes two mobile devices 12, 14 communicatively coupled to a network 16 via wireless access networks 18. An exemplary implementation of the mobile devices 12, 14 is described in FIG. 2. The context delivery system 10 further includes a server 20 communicatively coupled to the network 16. In an exemplary embodiment, the network 16 can include the Internet, Virtual Private Networks (VPNs), Local Area Networks (LANs), Wireless provider networks (e.g., 3G, 4G, etc.), Wireless LAN (WiFi, WLAN, etc.), satellite networks, mesh networks, private and/or government wireless networks, and combinations thereof. That is, the mobile devices 12, 14 can connect to the wireless access networks 18 which are communicatively coupled to a private or public IP network (such as Internet). The server 20 can be communicatively coupled to the network 16. In FIG. 1, these various networks are singularly illustrated by the network 16 for illustration purposes.

The server 20 is configured to interact with the mobile devices 12, 14 via the network 16, and the server 20 implements a group management function. Specifically, the mobile devices 12, 14 are in a group 22. Note, FIG. 1 illustrates two mobile devices 12, 14 in the group 22, but those of ordinary skill in the art will recognize that the group 22 can include an arbitrary number of mobile devices. Further, the mobile devices in the group 22 do not need to connect to a same wireless access networks 18 or even be part of a same wireless network as long as the mobile devices in the group 22 ultimately connect to the server 20. Generally, the group 22 includes the mobile devices 12, 14 which share updates and/or other content therebetween based on the group management function. The mobile devices 12, 14 can also be referred to as user equipment (UE) in the various descriptions herein.

Referring to FIG. 2, in an exemplary embodiment, a block diagram illustrates the mobile devices 12, 14 for use in the context delivery system 10 and the various methods described herein in accordance with some embodiments. The mobile device 12, 14 can be a digital device that, in terms of hardware architecture, generally includes a processor 30, input/output (I/O) interfaces 32, a network interface 34, a data store 36, memory 38, and sensors 40. It should be appreciated by those of ordinary skill in the art that FIG. 2 depicts the mobile devices 12, 14 in an oversimplified manner, and a practical embodiment can include additional components and suitably configured processing logic to support known or conventional operating features that are not described in detail herein. The components (30, 32, 34, 36, 38, and 40) are communicatively coupled via a local interface 42. The local interface 42 can be, for example but not limited to, one or more buses or other wired or wireless connections, as is known in the art. The local interface 42 can have additional elements, which are omitted for simplicity, such as controllers, buffers (caches), drivers, repeaters, and receivers, among many others, to enable communications. Further, the local interface 42 may include address, control, and/or data connections to enable appropriate communications among the aforementioned components.

The processor 30 is a hardware device for executing software instructions. The processor 30 can be any custom made or commercially available processor, a central processing unit (CPU), an auxiliary processor among several processors associated with the mobile device 12, 14, a semiconductor-based microprocessor (in the form of a microchip or chip set), or generally any device for executing software instructions. When the mobile device 12, 14 is in operation, the processor 30 is configured to execute software stored within the memory 38, to communicate data to and from the memory 38, and to generally control operations of the mobile device 12, 14 pursuant to the software instructions. In an exemplary embodiment, the processor 30 may include a mobile optimized processor such as optimized for power consumption and mobile applications.

The I/O interfaces 32 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, wearable display devices such as armband or shoulder mounted device, an earpiece or headphones, glasses with a virtualized display included therein, and the like. The I/O interfaces 32 can also include, for example, a serial port, a parallel port, a small computer system interface (SCSI), an infrared (IR) interface, a radio frequency (RF) interface, a universal serial bus (USB) interface, proprietary vendor interconnects (e.g., 30 pin adapter, 19 pin adapter, etc.), an audio jack, and the like. The I/O interfaces 32 can include a graphical user interface (GUI) that enables a user to interact with the mobile device 12, 14 Additionally, the I/O interfaces 32 may further include an imaging device, i.e. camera, video camera, etc., location device such as GPS, etc.

The network interface 34 enables wireless communication to an external access device or network, such as to the wireless access network 18. Any number of suitable wireless data communication protocols, techniques, or methodologies can be supported by the network interface 34, including, without limitation: RF; LMR; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; wireless mesh protocols; and any other protocols for wireless communication.

The data store 36 can be used to store data. The data store 36 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 36 can incorporate electronic, magnetic, optical, and/or other types of storage media. The memory 38 can include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 38 may incorporate electronic, magnetic, optical, and/or other types of storage media. Note that the memory 38 can have a distributed architecture, where various components are situated remotely from one another, but can be accessed by the processor 30.

The software in memory 38 can include one or more software programs, each of which includes an ordered listing of executable instructions for implementing logical functions. In the example of FIG. 2, the software in the memory system 38 includes a suitable operating system (O/S) 44 and programs 46. The operating system 44 essentially controls the execution of other computer programs, and provides scheduling, input-output control, file and data management, memory management, and communication control and related services. The programs 46 can include various applications, add-ons, etc. configured to provide end user functionality with the mobile device 12, 14. For example, exemplary programs 46 can include, but not limited to, a web browser, social networking applications, streaming media applications, games, mapping and location applications, electronic mail applications, financial applications, and the like.

The sensors 40 include a plurality of devices in the mobile device 12, 14 for gathering data related to the current context of the mobile device 12, 14. The sensors 40 are generally configured to provide data to the processor 30 to detect or sense events as described herein. Assuming the mobile device 12, 14 is associated with, disposed on, held by, etc. a responder, the sensed events can include, for example, detecting the responder is running, detecting the responder has fallen, detecting an elevated heart rate or other physical indicia of stress, detecting an injury to the responder, detecting the responder is on scene of an incident, and the like. That is, the sensors 40 are devices that gather real-time data and present the data to the processor 30 for processing thereof to detect a current context of the mobile device 12, 14. Exemplary devices for the sensors 40 can include, without limitation, an accelerometer, a heart monitor, a location tracking device such as GPS, biofeedback devices for real time feedback of various physical characteristics, gyroscopes, digital compasses, ambient light, and the like. In an exemplary embodiment, the mobile device 12, 14 can be configured to detect its own context based on processing and communication between the sensors 40 and the processor 30. In another exemplary embodiment, the mobile device 12, 14 can communicate sensor related data from the sensors 40 to the server 20 for a determination of the context at the server 20. In yet another exemplary embodiment, a combination of the two aforementioned embodiments can be employed.

In an exemplary embodiment, the programs 46 include instructions that, when executed, cause the processor to register for at least one group in a group management function (GMF) at a server; monitor the data from the at least one sensor; determine a context from the monitored data; send the context to the GMF at the server; receive an update related to a direction and a distance to a second mobile device which is part of the at least one group, wherein the update is based upon the second mobile device detecting a contextual event via at least one sensor associated with the second mobile device; and present the update based on the determined context.

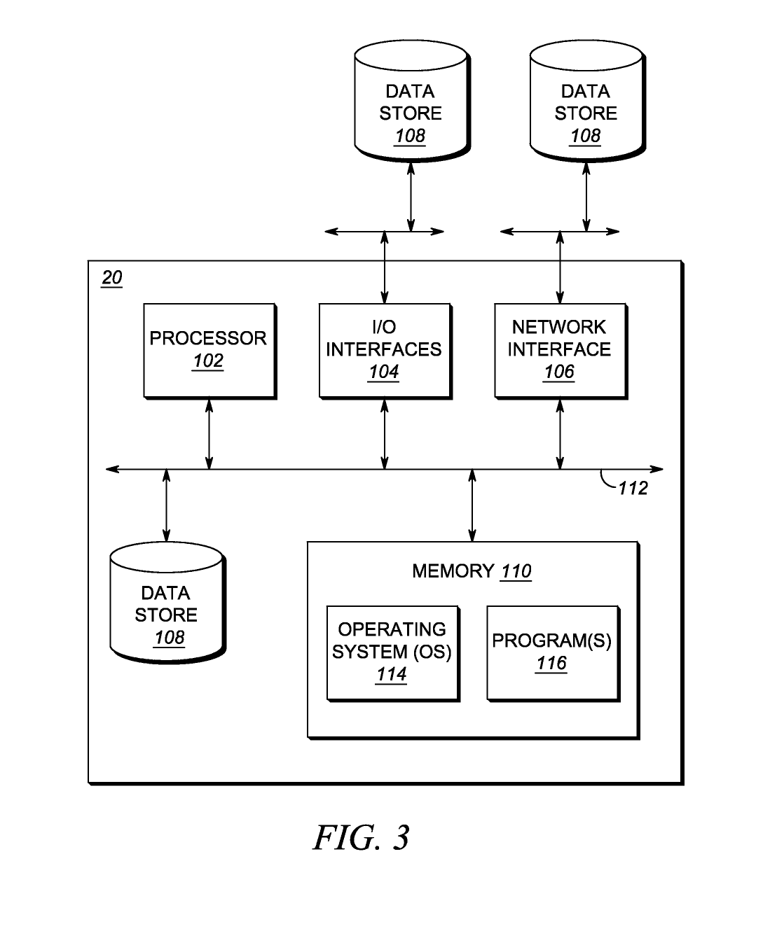

Referring to FIG. 3, in an exemplary embodiment, a block diagram illustrates an exemplary implementation of a server 20 for use in the context delivery system 10 and the various methods described herein in accordance with some embodiments. The server 20 can be a digital computer that, in terms of hardware architecture, generally includes a processor 102, input/output (I/O) interfaces 104, a network interface 106, a data store 108, and memory 110. It should be appreciated by those of ordinary skill in the art that FIG. 3 depicts the server 20 in an oversimplified manner, and a practical embodiment may include additional components and suitably configured processing logic to support known or conventional operating features that are not described in detail herein. The components (102, 104, 106, 108, and 110) are communicatively coupled via a local interface 112. The local interface 112 can be, for example but not limited to, one or more buses or other wired or wireless connections, as is known in the art. The local interface 112 can have additional elements, which are omitted for simplicity, such as controllers, buffers (caches), drivers, repeaters, and receivers, among many others, to enable communications. Further, the local interface 112 can include address, control, and/or data connections to enable appropriate communications among the aforementioned components.

The processor 102 is a hardware device for executing software instructions. The processor 102 can be any custom made or commercially available processor, a central processing unit (CPU), an auxiliary processor among several processors associated with the server 20, a semiconductor-based microprocessor (in the form of a microchip or chip set), or generally any device for executing software instructions. When the server 20 is in operation, the processor 102 is configured to execute software stored within the memory 110, to communicate data to and from the memory 110, and to generally control operations of the server 20 pursuant to the software instructions. The I/O interfaces 104 can be used to receive user input from and/or for providing system output to one or more devices or components. User input can be provided via, for example, a keyboard, touch pad, and/or a mouse. System output can be provided via a display device and a printer (not shown). I/O interfaces 104 can include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 106 can be used to enable the server 20 to communicate on a network, such as to communicate with the mobile devices 12, 14 via the network 16. The network interface 106 can include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 106 can include address, control, and/or data connections to enable appropriate communications on the network. A data store 108 can be used to store data. The data store 108 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 can incorporate electronic, magnetic, optical, and/or other types of storage media. In one example, the data store 108 can be located internal to the server 20 such as, for example, an internal hard drive connected to the local interface 112 in the server 20. Additionally in another embodiment, the data store 108 can be located external to the server 20 such as, for example, an external hard drive connected to the I/O interfaces 104 (e.g., SCSI or USB connection). In a further embodiment, the data store 108 can be connected to the server 20 through a network, such as, for example, a network attached file server.

The memory 110 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 110 can incorporate electronic, magnetic, optical, and/or other types of storage media. Note that the memory 110 can have a distributed architecture, where various components are situated remotely from one another, but can be accessed by the processor 102. The software in memory 110 can include one or more software programs, each of which includes an ordered listing of executable instructions for implementing logical functions. The software in the memory 110 includes a suitable operating system (O/S) 114 and one or more programs 116. The operating system 114 essentially controls the execution of other computer programs, such as the one or more programs 116, and provides scheduling, input-output control, file and data management, memory management, and communication control and related services. The one or more programs 116 may be configured to implement the various processes, algorithms, methods, techniques, etc. described herein.

In an exemplary embodiment, the server 20 is configured to execute a group management function which can be one of the programs 116. The group management function determines what updates are communicated between the mobile devices 12, 14 in the group and how the updates are communicated. In an exemplary embodiment, the group management function includes instructions that, when executed, cause the processor to receive, at the group management function (GMF), a contextual event and a location from of a first mobile device; determine, by the GMF, a set of one or more mobile devices for receiving an update related to the contextual event and the location of the first mobile device; receive, at the GMF, a context of a second mobile device in the set of one or more mobile devices; send, by the GMF, the contextual event and the location of the first mobile device to the set of one or more mobile devices; and instruct, by the GMF, the second mobile device to present information related to the distance and the direction to the first mobile device based upon the context of the second mobile device.

In an exemplary embodiment, the mobile devices 12, 14 are associated with a primary responder and a backup responder, respectively. The GMF is configured to present the contextual event and/or related information on the mobile devices 12, 14 in a format optimal based on the contextual event information. The format can include, without limitation, via augmented reality glasses or other worn displays, via a display map, via audio or text information, via silent indication, and the like. For example, the at least one mobile device is associated with a second responder who is backing up the first responder, and the server instructs the second mobile device to present the distance and the direction to the first responder in a format optimal based on the contextual event information. For example, if a mobile device senses a covert mode, audio presentation is not an optimal format.

Alternatively, the first mobile device is associated with a first responder, wherein the at least one mobile device is associated with a second responder who is backing up the first responder, and the server instructs the second mobile device to: present a distance and a direction to the first responder via augmented reality glasses when the second responder is running; present the distance and the direction to the first responder via a display map when the second responder is in a vehicle; present the distance and the direction to the first responder via a text or audio instructions when the second responder is out of broadband range; and present the distance and the direction to the first responder via text or audio in an earpiece when the second responder is in a covert mode.

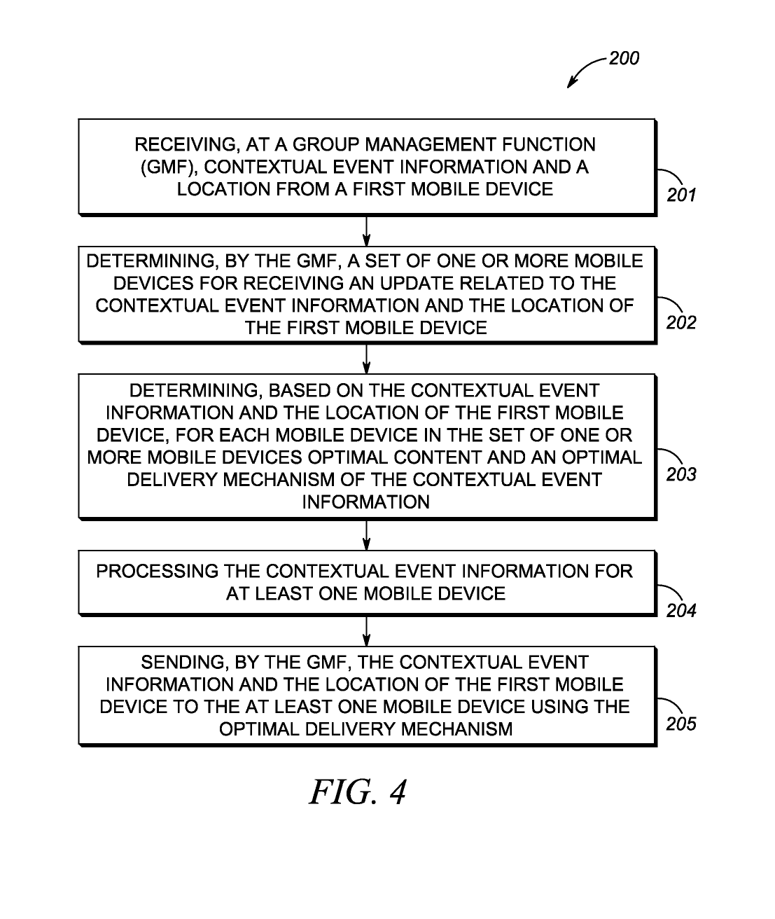

Referring to FIG. 4, in an exemplary embodiment, a flowchart illustrates a context-based method 200 in accordance with some embodiments. The context-based method 200 can be implemented by the context delivery system 10. The context-based method 200 includes receiving, at a group management function (GMF), contextual event information and a location from a first mobile device (step 201). As described herein, the contextual event can be any sensed event at or by the first mobile device. For example, the first mobile device is associated with a first responder, and the contextual event includes any of the first responder running, the first responder being injured, the first responder being under stress, the first responder subject to excessive heat or cold, the first responder being stationary for a predetermined time period, the first responder lacking brain activity, the first responder having a weapon out, the first responder being on duty, and the like. For example, contextual event information can be a report of one or more of the aforementioned contextual events or any other contextual event.

Some exemplary contexts can include, without limitation, a mode context (under cover/covert mode, normal, off duty), an alert context (emergency indication, etc.), a physical context (elevated heart rate, motionless for a period of time), a threat context (normal, agitated voice nearby, gunshot detection, weapon identified), a proximity context (near gang member, near felon, near crime scene, near incident, near vehicle, near responder, etc.), a mobility context (walking, running, falling, swimming, standing), a location context (at incident scene, en route, at agency, in building/out of building, location, direction, speed), an activity context (working on report, talking on phone, etc.), a preference context (want voice on earpiece, want video on wrist display, etc.), a device and accessory context (what devices do I currently have in my possession?, what is the battery level of each? What are the capabilities of each device? What networks can each device communicate with?), a weapon context (gun out of holster, billy club out of holster), a sensor context (e.g., radiation, chemical hazard, biohazard, etc.), and the like. Specifically, these exemplary contexts can be referred to as a plurality of categories.

The context-based method 200 further includes determining, by the GMF, a set of one or more mobile devices for receiving an update related to the contextual event information and the location of the first mobile device (step 202). The set of one or more mobile devices are all in the same group as the first mobile device meaning these mobile devices are configured, via the GMF, to receive updates based on the contextual event at the first mobile device. The context-based method 200 further includes determining, based on the contextual event information and the location of the first mobile device, for each mobile device in the set of one or more mobile devices optimal content and an optimal delivery mechanism of the contextual event information (step 203). Specifically, the context-based method 200 is configured to have the sender of the information (i.e., the first mobile device) affect the presentation of the information at the receiver.

The context-based method 200 further includes processing the contextual event information for at least one mobile device (step 204). Here, the context-based method 200 can transform the contextual event information based on how it will be presented to the at least one mobile device, i.e. based on the context and location of the first device. For example, severity of the first device's context can determine how it is delivered to the receiving group. This can include formatting the contextual event information for audio, graphical, text, and the like presentation to a plurality of different devices at the at least one mobile device. The formatting can be for the optimal delivery mechanism, and the optimal delivery mechanism is based on the contextual information of the first mobile device. For example, the context could be transformed for augmented reality glasses, wrist display, or other types of worn displays.

The context-based method 200 further includes sending, by the GMF, the contextual event information and the location of the first mobile device to the at least one mobile device using the optimal delivery mechanism (step 205). The contextual event information is used to constrain how the information from the first mobile device is presented at the at least one mobile device. Note, the processing of the content may occur in the back-end, i.e. prior to the sending. Alternatively, the processing of the content may occur in the device, i.e. subsequent to the sending. Finally, the processing may simply include no change to the content based on the context.

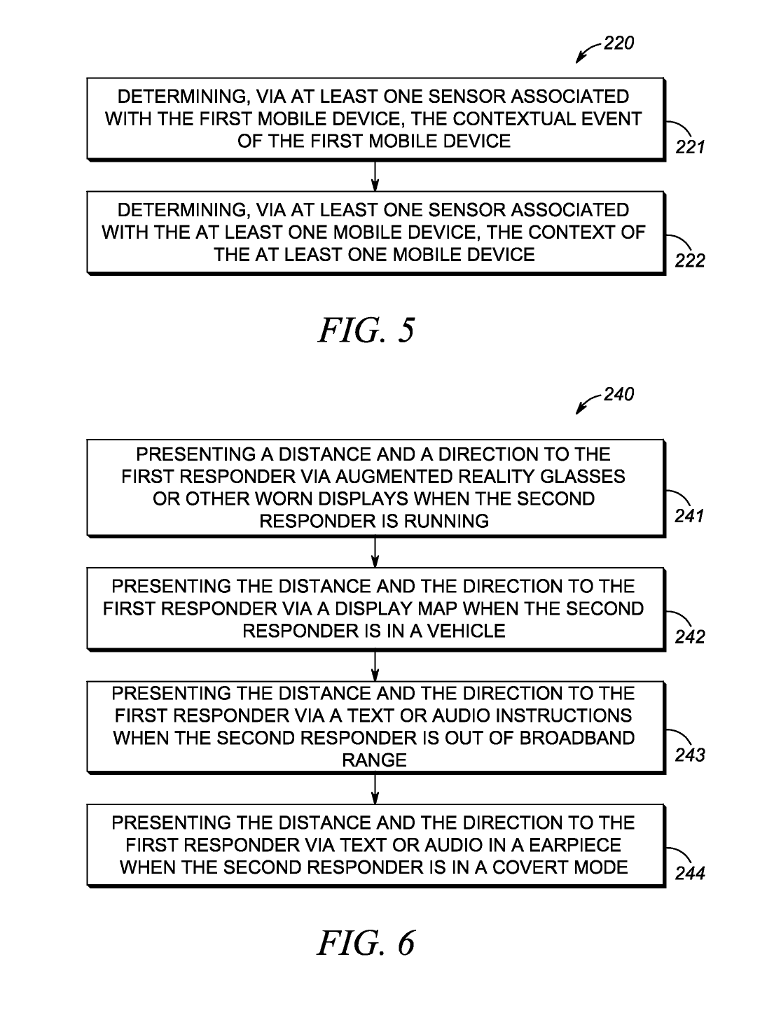

Referring to FIG. 5, in an exemplary embodiment, a flowchart illustrates a sensor method 220 for use with the context-based method 200 in accordance with some embodiments. The sensor method 220 includes determining, via at least one sensor associated with the first mobile device, the contextual event of the first mobile device (step 221). The sensor method 220 optionally further includes determining, via at least one sensor associated with the at least one mobile device, the context of the at least one mobile device (step 222). As described herein, the first mobile device and the at least one mobile device can include sensors such as, without limitation, an accelerometer, a heart monitor, a location tracking device such as GPS, biofeedback devices for real time feedback of various physical characteristics, gyroscopes, digital compasses, ambient light, and the like.

Referring to FIG. 6, in an exemplary embodiment, a flowchart illustrates a presentation method 240 for use with the context-based method 200 in accordance with some embodiments. Specifically, the first mobile device is associated with a first responder, and the at least one mobile device is associated with a second responder who is backing up the first responder. Alternatively, the first mobile device can be associated with a primary responder, and the at least one mobile device is associated with a backup responder. The presentation method 240 includes presenting a distance and a direction to the first responder via augmented reality glasses or other worn displays when the second responder is running (step 241). The presentation method 240 further includes presenting the distance and the direction to the first responder via a display map when the second responder is in a vehicle (step 242).

The presentation method 240 further includes presenting the distance and the direction to the first responder via a text or audio instructions when the second responder is out of broadband range (step 243). The presentation method 240 further includes presenting the distance and the direction to the first responder via text or audio in an earpiece when the second responder is in a covert mode (step 244). That is, the presentation method 240 includes presenting, by the at least one mobile device, the information related to the distance and the direction to the first mobile device via one of augmented reality glasses, a wrist display, a display associated with the at least one mobile device, and an earpiece based upon a current context of the at least one mobile device.

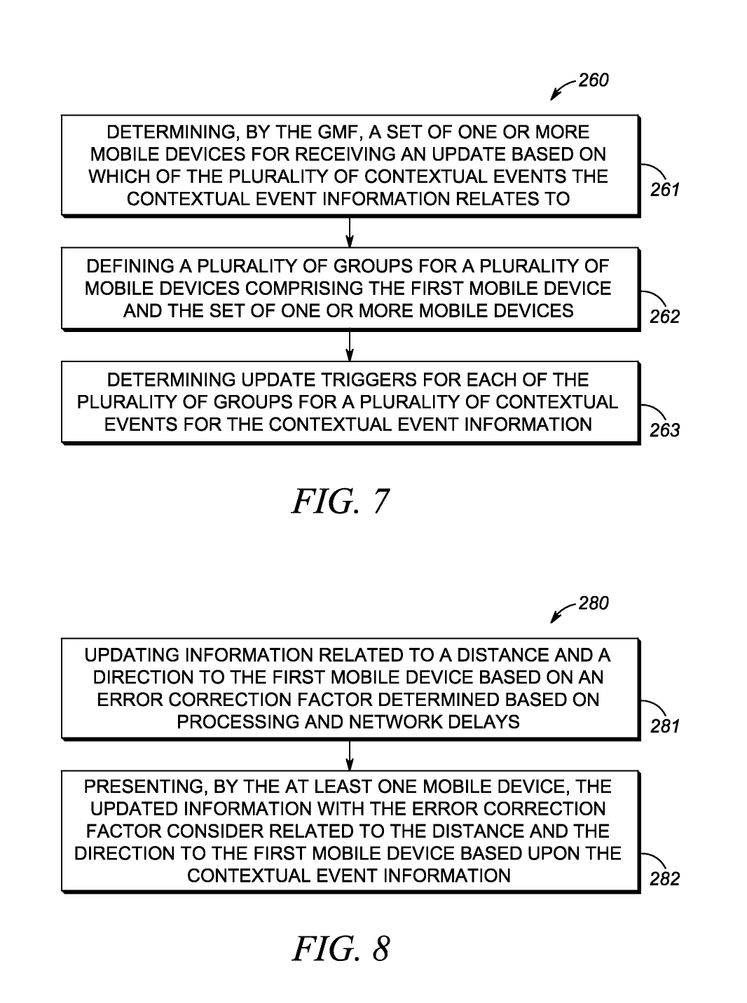

Referring to FIG. 7, in an exemplary embodiment, a flowchart illustrates a GMF method 260 for use with the context-based method 200 in accordance with some embodiments. The contextual event is one of a plurality of contextual events. That is, the context-based method 200 assumes more than one sensed event can be a contextual event. The GMF method 260 includes determining, by the GMF, a set of one or more mobile devices for receiving an update based on which of the plurality of contextual events the contextual event information relates to (step 261). Here, the GMF method 260 is defining updates for a group for contextual events.

The GMF method 260 further includes defining a plurality of groups for a plurality of mobile devices comprising the first mobile device and the set of one or more mobile devices (step 262). Here, the GMF method 260 defines group membership across known mobile devices. The GMF method 260 further includes determining update triggers for each of the plurality of groups for a plurality of contextual events for the contextual event information (step 263). Here, the GMF method 260 is determining how updates are handled for the groups. For example, one group may include police officers, and an exemplary contextual event could be one of your partners is injured or in danger. Another group may include fire fighters, and an exemplary contextual event could be smoke inhalation or extreme heat.

Referring to FIG. 8, in an exemplary embodiment, a flowchart illustrates a distance correction method 280 for use with the context-based method 200 in accordance with some embodiments. Specifically, when the distance and direction is presented to the at least one mobile device, there is a possibility of error due to processing and network delays. The distance correction method 280 provides a mechanism to correct any such error. The distance correction method 280 includes updating information related to a distance and a direction to the first mobile device based on an error correction factor determined based on processing and network delays (step 281). The processing and network delays can be determined at the server 20 and/or the mobile devices 12, 14, and it can be based on latency, timestamps, etc.

The distance correction method 280 includes presenting, by the at least one mobile device, the updated information with the error correction factor consider related to the distance and the direction to the first mobile device based upon the contextual event information (step 282). For example, assume a delay of half a second, and that the first mobile device is determined to be moving 50 mph on a specific street, the distance correction method 280 can accommodate this by updating the directions and location to the first mobile device based on all of these factors.

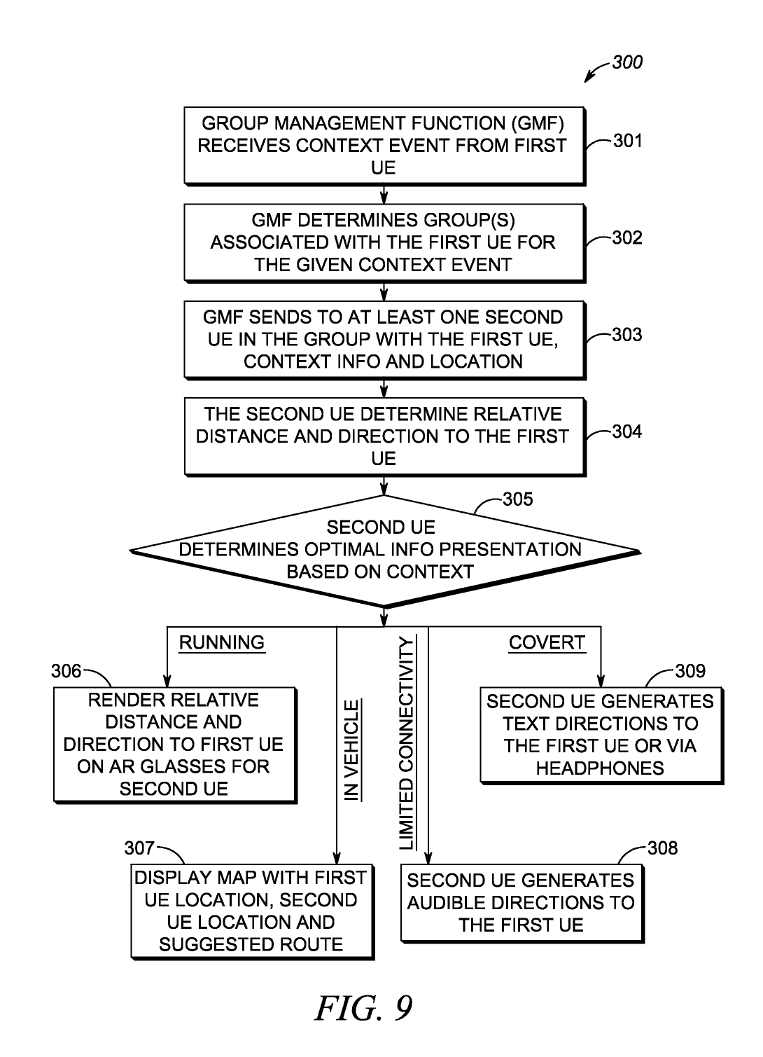

Referring to FIG. 9, in an exemplary embodiment, a flowchart illustrates a GMF method 300 for use with the context delivery system 10 in accordance with some embodiments. The GMF method 300 includes receiving a context event, i.e. contextual event, from a first UE (step 301). The GMF method 300 further includes determining group(s) associated with the first UE for the given context event (step 302). The GMF method 300 further includes sending to at least one second UE in the group with the first UE, the context info and location of the first UE (step 303). The GMF method 300 further includes the second UE determining relative distance and direction to the first UE (step 304).

The GMF method 300 further includes the second UE determining optimal info presentation based on a context of the second UE (step 305). The GMF method 300 includes rendering relative distance and direction to the second UE on augmented reality glasses when a user of the second UE is running (step 306). The GMF method 300 includes displaying a map with the first UE location, second UE location, and a suggested route when the user is in a vehicle (step 307). The GMF method 300 includes generating audile or text directions to the first UE when the second UE has limited or no network connectivity (step 308). The GMF method 300 includes generating text directions and/or providing an audile alert when the user is in a covert mode (step 309).

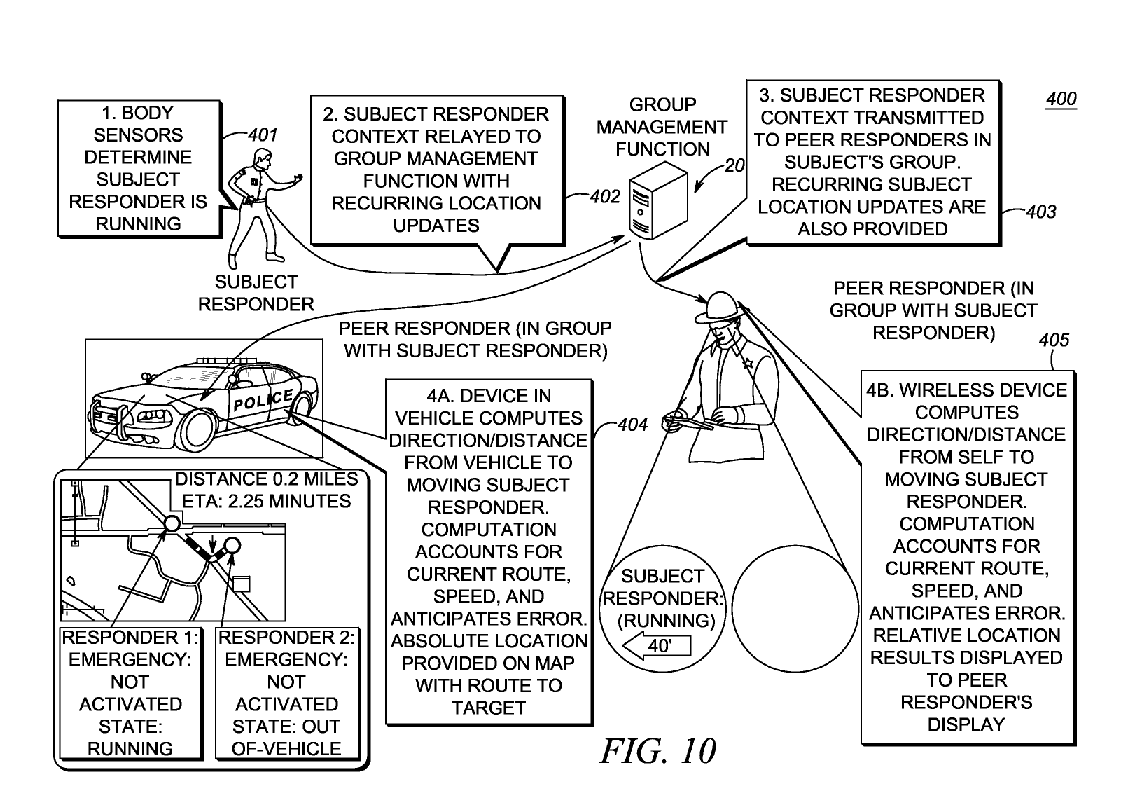

Referring to FIG. 10, in an exemplary embodiment, a diagram illustrates an exemplary operation 400 using the context-based systems and methods described herein in accordance with some embodiments. First, a subject responder with a first mobile device determines a contextual event with body sensors determining the subject responder is running (step 401). The subject responder's context is relayed to the GMF at the server 20 with recurring location updates (step 402). The GMF determines which peer responders in the subject responder's group should receive the context, location, and updates (step 403). A first peer responder is in a vehicle and an associated mobile device computes direction and distance from the vehicle to the subject responder (step 404). This computation accounts for current route, speed, and anticipates error. Further, the associated mobile device can cause the information to be presented on a visual display. A second peer responder is on foot and computes direction and distance from an associated mobile device (step 405). The second peer responder can have the info presented via augmented reality glasses.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A context-based method, comprising:
receiving, at a group management function (GMF), contextual event information and a location from a first mobile device;
determining, by the GMF, a set of one or more mobile devices for receiving an update related to the contextual event information and the location of the first mobile device;
determining, based on the contextual event information and the location of the first mobile device, for each mobile device in the set of one or more mobile devices optimal content and an optimal delivery mechanism of the contextual event information;
processing the contextual event information for at least one mobile device; and
sending, by the GMF, the contextual event information and the location of the first mobile device to the at least one mobile device using the optimal delivery mechanism.

2. The context-based method of claim 1, further comprising:
determining, via at least one sensor associated with the first mobile device, the contextual event of the first mobile device; and
determining, via at least one sensor associated with the at least one mobile device, the context of the at least one mobile device.

3. The context-based method of claim 2, wherein the first mobile device is associated with a first responder, and wherein the contextual event information comprises any of the first responder running, the first responder being injured, the first responder being under stress, the first responder subject to excessive heat or cold, the first responder being stationary for a predetermined time period, the first responder lacking brain activity, the first responder having a weapon out, and the first responder being on duty.

4. The context-based method of claim 3, wherein the at least one mobile device is associated with a second responder who is backing up the first responder, and wherein the presenting step provides the distance and the direction to the first responder in a format optimal based on the contextual event information.

5. The context-based method of claim 1, wherein the first mobile device is associated with a first responder, wherein the at least one mobile device is associated with a second responder who is backing up the first responder, and further comprising:
presenting a distance and a direction to the first responder via augmented reality glasses or other worn displays when the second responder is running;
presenting the distance and the direction to the first responder via a display map when the second responder is in a vehicle;
presenting the distance and the direction to the first responder via a text or audio instructions when the second responder is out of broadband range; and
presenting the distance and the direction to the first responder via text or audio in an earpiece when the second responder is in a covert mode.

6. The context-based method of claim 1, further comprising:
presenting, by the at least one mobile device, the information related to a distance and a direction to the first mobile device via one of augmented reality glasses, a wrist display, a display associated with the at least one mobile device, and an earpiece based upon the contextual event information.

7. The context-based method of claim 1, wherein the contextual event information comprises one of a plurality of contextual events, and further comprising:
determining, by the GMF, a set of one or more mobile devices for receiving an update based on which of the plurality of contextual events the contextual event information relates to.

8. The context-based method of claim 1, further comprising:
defining a plurality of groups for a plurality of mobile devices comprising the first mobile device and the set of one or more mobile devices; and
determining update triggers for each of the plurality of groups for a plurality of contextual events for the contextual event information.

9. The context-based method of claim 1, further comprising:
updating information related to a distance and a direction to the first mobile device based on an error correction factor determined based on processing and network delays; and
presenting, by the at least one mobile device, the updated information with the error correction factor consider related to the distance and the direction to the first mobile device based upon the contextual event information.

10. The context-based method of claim 1, wherein the contextual event information related to one of a plurality of categories comprising a mode context, an alert context, a physical context, a threat context, a proximity context, a mobility context, a location context, an activity context, a preference context, a device and accessory context, a weapon context, and a sensor context.

11. A server implementing a group management function, comprising:
a network interface communicatively coupled to a plurality of mobile devices over a network;
a processor communicatively coupled to the network interface; and
memory storing instructions that, when executed, cause the processor to:
receive, at the group management function (GMF), contextual event information and a location from of a first mobile device;
determine, by the GMF, a set of one or more mobile devices for receiving an update related to the contextual event information and the location of the first mobile device;
process the contextual event information for at least one mobile device in the set of one or more mobile devices; and
send, by the GMF, the processed contextual event information and the location of the first mobile device to the at least one mobile device using the optimal delivery mechanism.

12. The server of claim 11, wherein the first mobile device is associated with a first responder, and wherein the contextual event information comprises any of the first responder running, the first responder being injured, the first responder being under stress, the first responder subject to excessive heat or cold, the first responder being stationary for a predetermined time period, the first responder lacking brain activity, the first responder having a weapon out, and the first responder being on duty.

13. The server of claim 12, wherein the at least one mobile device is associated with a second responder who is backing up the first responder, and wherein the server instructs the second mobile device to present the distance and the direction to the first responder in a format optimal based on the contextual event information.

14. The server of claim 11, wherein the first mobile device is associated with a first responder, wherein the at least one mobile device is associated with a second responder who is backing up the first responder, and wherein the server instructs the second mobile device to:
present a distance and a direction to the first responder via augmented reality glasses when the second responder is running;
present the distance and the direction to the first responder via a display map when the second responder is in a vehicle;
present the distance and the direction to the first responder via a text or audio instructions when the second responder is out of broadband range; and
present the distance and the direction to the first responder via text or audio in a earpiece when the second responder is in a covert mode.

15. The server of claim 11, wherein the instructions that, when executed, further cause the processor to:
register a plurality of mobile devices comprising the first mobile device and the at least one mobile device;
define a plurality of groups for the plurality of mobile devices; and
determine update triggers for each of the plurality of groups for a plurality of contextual events.

16. A mobile device, comprising:
a network interface communicatively coupled to a network;
at least one sensor capturing data;
a processor communicatively coupled to the network interface and the at least one sensor; and
memory storing instructions that, when executed, cause the processor to:
register for at least one group in a group management function (GMF) at a server;
monitor the data from the at least one sensor;
determine a context from the monitored data;
send the context to the GMF at the server;
receive an update related to a direction and a distance to a second mobile device which is part of the at least one group, wherein the update is based upon the second mobile device detecting a contextual event via at least one sensor associated with the second mobile device; and
present the update based on the determined context.

17. The mobile device of claim 16, wherein the second mobile device is associated with a primary responder, and wherein the contextual event information related to one of a plurality of categories comprising a mode context, an alert context, a physical context, a threat context, a proximity context, a mobility context, a location context, an activity context, a preference context, a device and accessory context, a weapon context, and a sensor context.

18. The mobile device of claim 17, wherein the mobile device is associated with a backup responder who is backing up the primary responder, and wherein the mobile device provides the distance and the direction to the primary responder in a format optimal to the context of the mobile device.

19. The mobile device of claim 16, wherein the second mobile device is associated with a primary responder, wherein the mobile device is associated with a backup responder who is backing up the primary responder, and wherein the mobile device is configured to:
present the distance and the direction to the primary responder via augmented reality glasses when the backup responder is running;
present the distance and the direction to the primary responder via a display map when the backup responder is in a vehicle;
present the distance and the direction to the primary responder via a text or audio instructions when the backup responder is out of broadband range; and
present the distance and the direction to the primary responder via text or audio in a earpiece when the backup responder is in a covert mode.

20. The mobile device of claim 16, wherein the instructions that, when executed, further cause the processor to:
update the information related to the distance and the direction to the second mobile device based on an error correction factor determined based on processing and network delays; and
adjust the information with the error correction factor.
